(19) United States
(12) Patent Application Publication
(10) Pub. No.: US 2013/0049981 A1
(43) Pub. Date: Feb. 28, 2013

(54) DRILLING DYNAMICS DATA VISUALIZATION IN REAL TIME

(71) Applicants: John MacPherson, Spring, TX (US); Michael King, Houston, TX (US); Darin J. Warling, Minneapolis, MN (US); Hanno Reckmann, Nienhagen (DE)

(72) Inventors: John MacPherson, Spring, TX (US); Michael King, Houston, TX (US); Darin J. Warling, Minneapolis, MN (US); Hanno Reckmann, Nienhagen (DE)

(73) Assignee: Baker Hughes Incorporated, Houston, TX (US)

(21) Appl. No.: 13/222,378

(22) Filed: Aug. 31, 2011

(51) Int. Cl. G01V 3/00

(52) U.S. Cl. 340/853.1

(57) ABSTRACT

Disclosed is an apparatus for displaying three-dimensional motion of a drill string in a borehole penetrating the earth to a user in real time. The apparatus includes: an accelerometer configured to measure acceleration in at least three directions; a strain sensor configured to measure strain or a bending moment at the drill string in two directions; a magnetometer and configured to measure an earth's magnetic field to determine rotational velocity of the drill string; a processor disposed at a surface of the earth and configured to receive the measurements from the accelerometer, the strain sensor, and the magnetometer and to process these measurements to estimate the three-dimensional motion of the drill string; a display configured to display the motion of the drill string to the user; and a high-speed telemetry system configured to transmit measurements from the accelerometer, the strain sensor, and the magnetometer to the processor in real time.

### BACKGROUND

Boreholes are drilled deep into the earth for many applications such as carbon dioxide sequestration, geothermal production, and hydrocarbon exploration and production. A borehole is typically drilled using a drill bit disposed at a distal end of a series of coupled drill pipes referred to as a drill string. As the borehole gets deeper, the drill string generally becomes highly flexible and exhibits axial, torsional, and lateral vibrations while drilling. When these vibrations are severe, the rate of penetration can decrease and damage to downhole tools and components can occur resulting in increased drilling costs. Hence, it would be well received in the drilling industry if an operator could be provided with accurate knowledge of the downhole dynamics of the drill string in order to be able to reduce severe downhole vibrations and increase the rate of penetration.

### BRIEF SUMMARY

Disclosed is an apparatus for displaying three-dimensional motion of a drill string in a borehole penetrating the earth to a user in real time. The apparatus includes: an accelerometer disposed in the borehole at the drill string and configured to measure acceleration in at least three different directions; a strain sensor disposed in the borehole at the drill string and configured to measure strain or a bending moment at the drill string in two different directions; a magnetometer disposed in the borehole at the drill string and configured to measure an earth's magnetic field to determine rotational velocity of the drill string; a processor disposed at a surface of the earth and configured to receive the measurements from the accelerometer, the strain sensor, and the magnetometer to process these measurements to estimate the three-dimensional motion of the drill string; a display coupled to the processor and configured to display the three-dimensional motion of the drill string to the user; and a high-speed telemetry system configured to transmit measurements from the accelerometer, the strain sensor, and the magnetometer to the processor in real time.

Also disclosed is a method for displaying three-dimensional motion of a drill string in a borehole penetrating the earth to a user in real time. The method includes: disposing in the borehole at the drill string an accelerometer configured to measure acceleration in at least three different directions, a strain sensor configured to measure strain or a bending moment at the drill string in two different directions, and a magnetometer configured to measure an earth's magnetic field to determine rotational velocity of the drill string; transmitting measurements from the accelerometer, the strain sensor, and the magnetometer to a processor disposed at a surface of the earth in real time using a high-speed telemetry system; processing the acceleration measurements, the strain sensor measurements, and the magnetometer measurements with the processor to estimate the three-dimensional motion of the drill string downhole; and displaying the three-dimensional motion to the user in real time using a display.

Further disclosed is an apparatus for displaying three-dimensional motion of a drill string in a borehole penetrating the earth to a user in real time. The apparatus includes: an accelerometer disposed in the borehole at the drill string and configured to measure acceleration in at least three different directions; a strain sensor disposed in the borehole at the drill string and configured to measure strain or a bending moment at the drill string in two different directions; a magnetometer disposed in the borehole at the drill string and configured to measure an earth's magnetic field to determine rotational velocity of the drill string; a processor disposed downhole at the drill string and configured to receive the measurements from the accelerometer, the strain sensor, and the magnetometer to process these measurements to estimate the three-dimensional motion of the drill string; a display disposed at the surface of the earth and coupled to the processor and configured to display the three-dimensional motion of the drill string to the user; and a high-speed telemetry system configured to transmit processed data related to the estimate of the three-dimensional motion from the processor to the display in real time.

Further disclosed is a method for displaying three-dimensional motion of a drill string in a borehole penetrating the earth to a user in real time. The method includes: disposing in the borehole at the drill string an accelerometer configured to measure acceleration in at least three different directions, a strain sensor configured to measure strain or a bending moment at the drill string in two different directions, and a magnetometer configured to measure an earth's magnetic field to determine rotational velocity of the drill string; receiving measurements from the accelerometer, the strain sensor, and the magnetometer with a processor disposed downhole at the drill string; processing the acceleration measurements, the strain sensor measurements, and the magnetometer measurements with the processor to estimate the three-dimensional motion of the drill string downhole; transmitting data related to the estimate of the three-dimensional motion from the processor to a display disposed at a surface of the earth in real time using a high-speed telemetry system; and displaying the three-dimensional motion to the user in real time using the display.

### BRIEF DESCRIPTION OF THE DRAWINGS

The following descriptions should not be considered limiting in any way. With reference to the accompanying drawings, like elements are numbered alike:

FIG. 1 illustrates an exemplary embodiment of a downhole tool disposed in a borehole penetrating the earth;

FIG. 2 depicts aspects of sensors disposed in a bottom hole assembly (BHA) at the drill string;

FIG. 3 depicts aspects of a surface display of data obtained from the sensors;

FIG. 4 depicts aspects of another surface display of data obtained from the sensors;

FIG. 5 presents one example of an algorithm for processing data from the downhole sensors to estimate three-dimensional motion of the BHA; and

FIG. 6 presents one example of a method for displaying three-dimensional motion of a drill string in a borehole penetrating the earth to a user in real time.

### DETAILED DESCRIPTION

A detailed description of one or more embodiments of the disclosed apparatus and method presented herein by way of exemplification and not limitation with reference to the Figures.

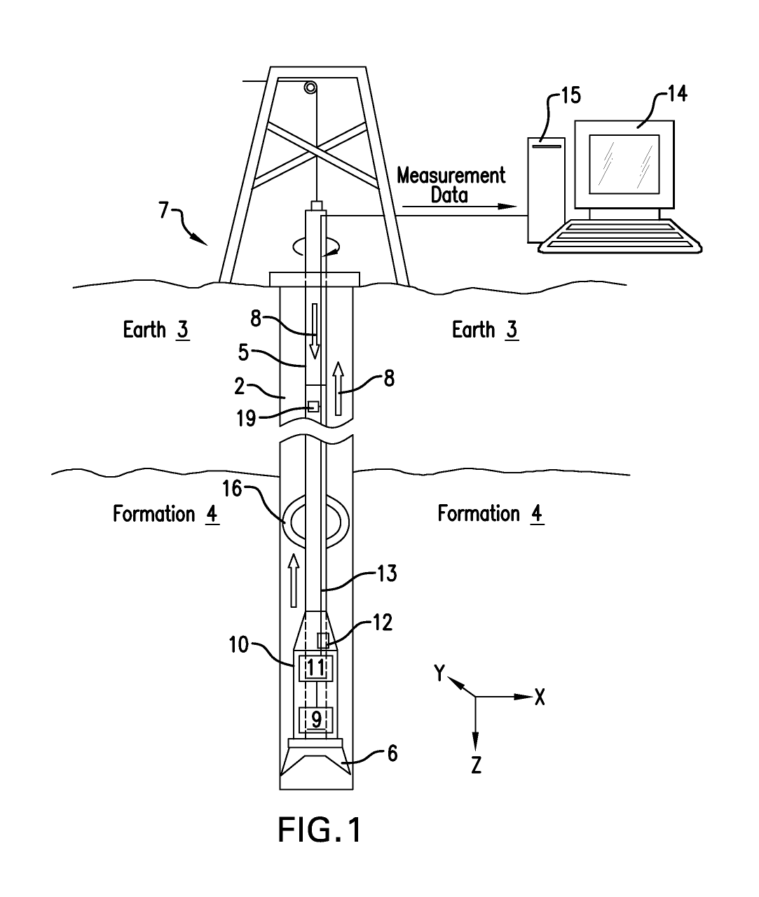

FIG. 1 illustrates an exemplary embodiment of a drill string 5 disposed in a borehole 2 penetrating the earth 3, which includes an earth formation 4. Disposed at the distal end of the drill string 5 is a drill bit 6. A drill rig 7 conducts drilling operations that include rotating the drill string 5 in order to turn the drill bit 6 to drill the borehole 2. The drill rig 7 pumps drilling fluid 8 downhole through the interior of the drill string 5 to lubricate the drill bit 6 and to flush cuttings into the borehole annulus exterior to the drill string 5. A stabilizer 16 provides a bias to the drill string 5 to keep the drill string 5 centered in the borehole 2.

Still referring to FIG. 1, a bottom hole assembly (BHA) 10 is disposed at the drill string 5 near the drill bit 6. In one or more embodiments, the BHA 10 is a collar surrounding the drill string 5 and having an outside diameter that is less than the diameter of the borehole 2. The BHA 10 includes a plurality of sensors 9 that are configured to sense or measure various parameters of the drilling operation. The plurality of sensors 9 is discussed in more detail below. An electronic unit 11 disposed in the BHA 10 receives data from the plurality of sensors 9 for processing and/or transmission to a computer processing system 15 disposed at the surface of the earth 3. The data is transmitted to the computer processing system 15 in real time using a high-speed telemetry system 12 such as wired drill pipe 13, which can transmit data at speeds at or exceeding 57 kilobits per second. The term “high speed” relates to a rate of data transfer that exceeds the data transfer rates of mud pulse, electromagnetic and acoustic telemetry that are typically less than 1,000 bits per second. The high-speed telemetry system 12 can include signals of the electrical or optical type. The computer processing system 15 includes a display 14 for displaying sensed or processed data from the plurality of sensors 9 to an operator or user. In one or more embodiments, one or more sensor packages 19 are distributed along the drill string 5. Each sensor package 19 includes downhole sensors similar to or the same as the plurality of sensors 9. The downhole sensors in each sensor package 19 are coupled to the high-speed telemetry system 12 in order to transmit measurements to the computer processing system 15 for processing similar to the processing of measurements received from the plurality of sensors 9.

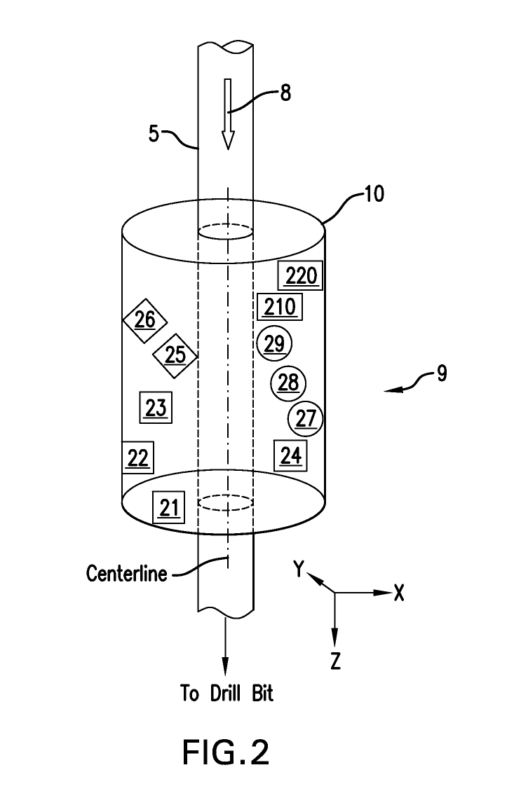

Reference may now be had to FIG. 2, which depicts aspects of the plurality of sensors 9 disposed at the BHA 10. A first strain gauge 21 is configured to measure weight on bit (WOB) implying that the BHA 10 is close to the drill bit 6. A second strain gauge 22 is configured to measure torque experienced by the drill string 5 at the BHA 10 and may be referred to as torque on bit when the BHA is close to the drill bit 6. A third strain gauge 23 and a fourth strain gauge 24 are configured to measure bending of the drill string 5 at the BHA 10 in two orthogonal directions X and Y, respectively. A first pressure sensor 25 is configured to measure pressure interior to the drill string 5 and a second pressure sensor 26 is configured to measure pressure in the annulus of the borehole 2. A first accelerometer 27, a second accelerometer 28 and a third accelerometer 29 form a three-axis accelerometer package. The accelerometer package can be mounted on the centerline of the BHA 10 or it can be mounted offset from the centerline and compensated for the offset. The package is configured to measure acceleration experienced by the BHA 10 along three orthogonal axes —X, Y and Z (i.e., lateral acceleration in X-Y plane normal to the centerline of the BHA and axial acceleration in Z direction). It is recognized that in certain situations the X-Y plane may not be normal to the centerline of the borehole, but that the plane may intersect the borehole at a non-normal angle. A temperature sensor 20 is configured to measure downhole temperature. A first magnetometer 210 and a second magnetometer 220 are configured to measure magnetic fields orthogonal to each other in order to monitor the downhole rotational velocity of the drill string 5 in vertical or deviated boreholes. Alternatively, rotational velocity of the drill string can be measured using a radial acceleration measurement normal to the centerline of the BHA.

In one or more embodiments, the electronic unit 9 is configured to process sensor data downhole to perform diagnostic checks of the downhole drilling operation. For example, an algorithm performed by the electronic unit 9 processes signals from the first and second magnetometers 210 and 220 to determine the instantaneous and the average rotational velocity. Another algorithm is applied to signals received from the third and fourth strain gauges 23 and 24. The combined results provide an input to determine a whirl diagnostic check. If whirl is diagnosed, then a diagnostic flag or alert is triggered. The diagnostic flag is then transmitted by the telemetry system 12 to the computer processing system 15 for display to the operator. Non-limiting embodiments of the diagnostic checks include bit bounce, stick/slip, forward and backward whirl, torque shocks, severe axial acceleration or vibration, severe lateral acceleration or vibration, severe torsional loads or vibrations, severe drill string bending, and bit cutting efficiency where “severe” relates to exceeding a specified threshold or graduated thresholds. Alternatively, the computer processing system 11 receives data from the plurality of sensors 9 and performs the diagnostic checks.

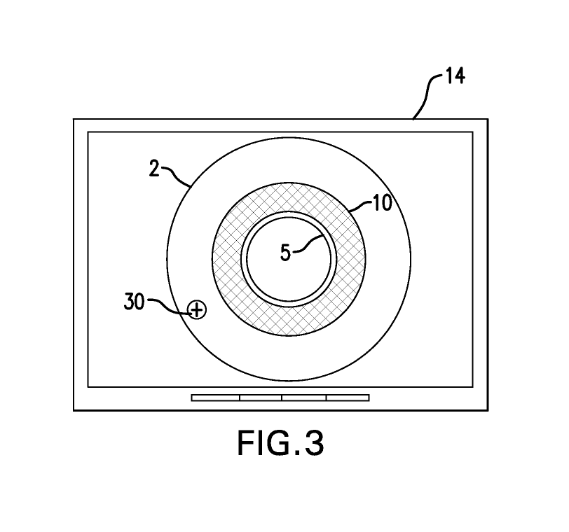

Reference may now be had to FIG. 3, which depicts aspects of displaying motion of the BHA 10. In one or more embodiments, three-dimensional motion or movement of the BHA 10 in the borehole 2 is displayed in real time to an operator on the display 14 as the borehole 2 is being drilled. In one or more embodiments, the three-dimensional motion is determined by the surface computer processing system 15 by implementing an algorithm that receives inputs from the downhole sensors discussed above. Alternatively, the algorithm can be implemented by the downhole electronic unit 11 and processed data related to the determined three-dimensional motion is transmitted to the display 14 by the high-speed telemetry system 12. This algorithm is discussed in detail below. In one or more embodiments, lateral motion of the BHA 10 is depicted on the display 14 by motion in the plane of the display 14 and axial motion is depicted by the BHA 10 appearing smaller (to depict motion away from the viewer) or larger (to depict motion towards the viewer). In one or more embodiments, a reference point 30 may be displayed on an image of a portion of the drill string 5 in order to observe rotation of the drill string 5.

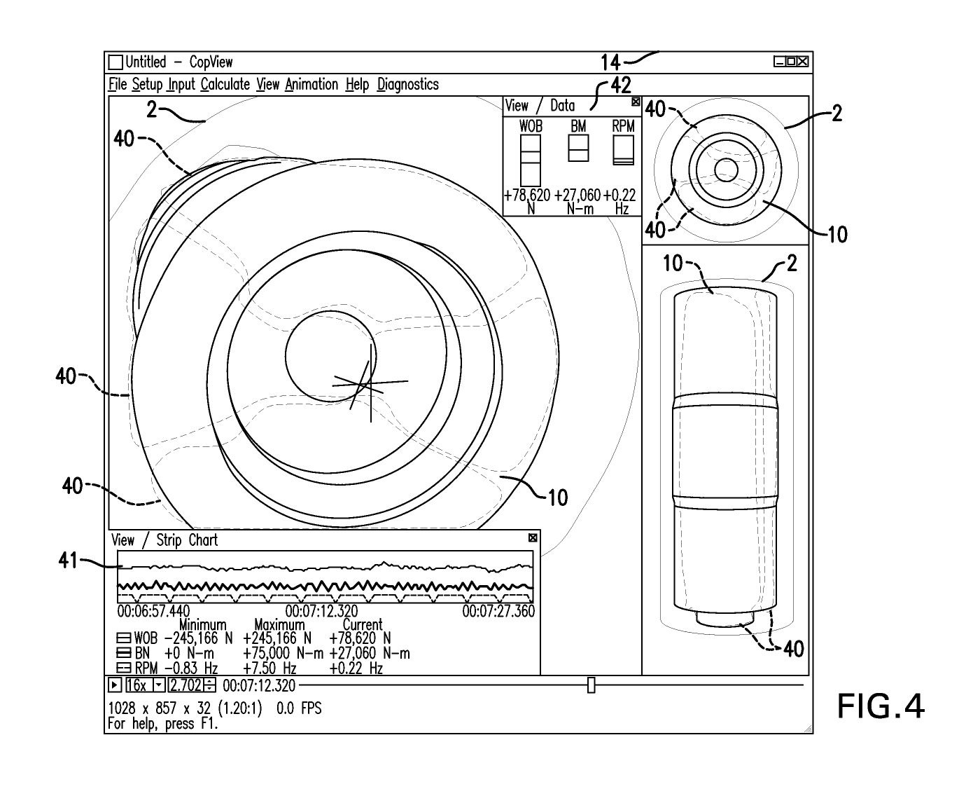

Reference may now be had to FIG. 4, which depicts aspects of another embodiment for displaying motion of the BHA 10. In the embodiment of FIG. 4, the display 14 illustrates a three-dimensional view of the BHA 10 and, accordingly, movement of the BHA 10 is illustrated in the three dimensions. In addition, the display 14 displays a cross-sectional view and a side view of the BHA 10. Each of the views of the BHA 10 in FIG. 4 includes shading 40 to depict other parameters of the BHA 10. The shading 40 can be various shades of gray or various shades of colors. In the embodiment of FIG. 4, all exposed surfaces in all views are shaded to represent load or bending moment values. The enclosed dashed-lines represent areas having different shaded colors and thus different load values. In one or more embodiments, shading of one color can represent one parameter while shading of another color can represent another parameter. Non-limiting embodiments of the other parameters include measurements performed by the one or more of the strain gauges 21-24 such as weight on bit, drill string torque or torque on bit, or a bending moment.

Still referring to FIG. 4, a trace 41 of raw data from one or more downhole sensors 9 is displayed. In addition, bar charts 42 representing instantaneous raw data or derived data is also displayed. In one or more embodiments, the bar charts 42 present data such as weight on bit, torque on bit, and rotational velocity.

From the three-dimensional display of motion, the operator can readily detect drill string motion problems as the problems develop or before they occur. For example, by knowing the direction of rotation of the drill string 5 (i.e., clockwise in FIG. 3), the operator can observe forward whirl or backward whirl as they occur. Forward whirl occurs when a component of the drilling assembly such as the drill bit 6, the BHA 10 or the drill string 5 moves in a generally circular motion within the borehole 2, which may be larger than the diameter of the drill bit 6, in the same circular direction as the rotation of the drill string 5. Backward whirl occurs when a component of the drilling assembly moves in a generally circular motion within the borehole 2 that is opposite of the direction of rotation of the drill string 5. Bit bounce can be observed by seeing the BHA 10 bounce and thus observing the drill bit 6 momentarily lose contact with or bounce from the formation 4 being drilled in front of the drill bit 6. Stick/slip can be observed by seeing the rotational speed of the drill string 5 slow down or stop due to friction between the drill bit 6 or the BHA 10 and borehole wall and then suddenly increase as the friction lessens. Axial vibrations can be observed similarly to bit bounce if the frequency is low enough to be observable. Lateral vibrations and collisions with the wall of the borehole 2 can also be observed. Some or all of these motions can be observed simultaneously.

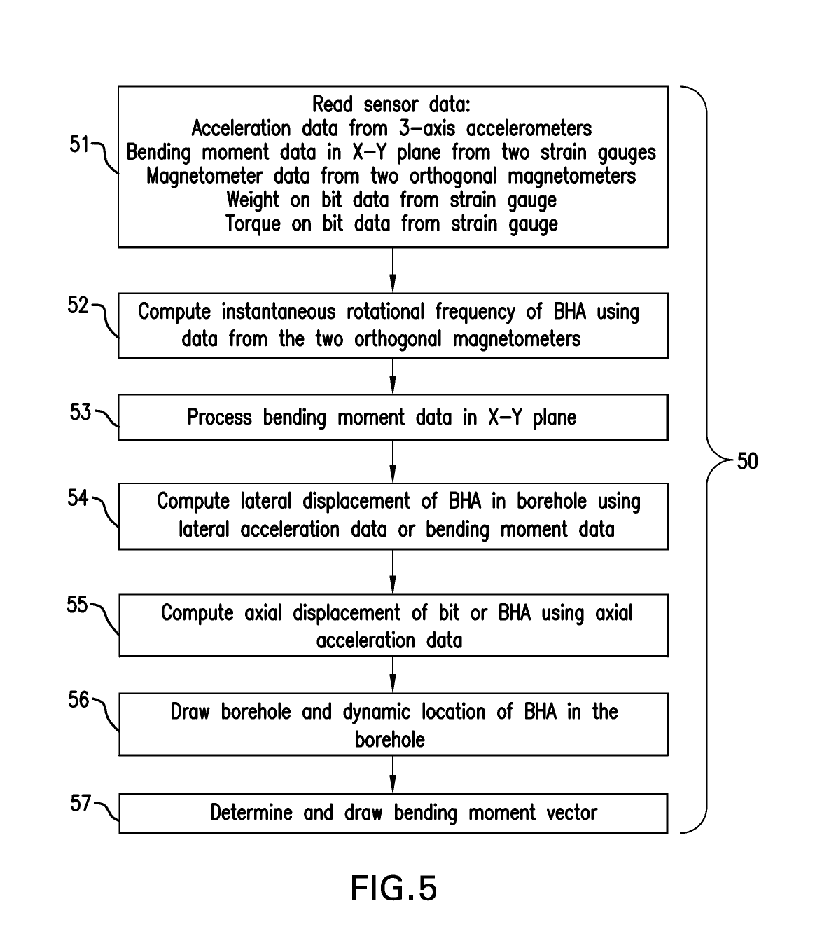

FIG. 5 presents one example of an algorithm 50 configured to be performed by the computer processing system 11 for visualization of displacements and stresses in the drill string 5. The following non-limiting conventions, constants, inputs, and derived inputs are used for teaching purposes.

The conventional drill string rotation is clockwise looking downhole (i.e., in a mathematically negative direction).

Constants:

π=3.141592

### E=30,000,000 psi: Young's Modulus

g=g*32.2*12.0 (inch units): For acceleration in ‘g’ units

Inputs:

(i) Sample rate (sr)
(ii) Borehole Diameter (dₕ) (inch)
(iii) BHA Diameter—outside and inside dₒ, d, (inch)
(iv) Location of sensor between bit and first stabilizer, (Lₛ) (inch), measured from bit
(v) Location of first stabilizer from bit, L (inch), measured from bit

### Derived Inputs:

$$I = \frac{π}{64} [ {d}_{o}^{4} - {d}_{i}^{4} ] \text{:} Moment of Inertia$$

$$con = \frac{{π}^{2} EI}{{L}^{2}} sin ( \frac{π {L}_{s}}{L} ) : Constant used to determined bending radius of drill string , using Bending Moment measurement$$

Step 51 calls for reading the following sensor data files:
(i) Acceleration: lateral aₓ(t) in x-direction and a_{y}(t) in y-direction and axial a_{z}(t) in the z-direction
(ii) Bending moment—bₓ(t) in x-direction and b_{y}(t) in y-direction
(iii) Magnetometer measurements—magx in x-direction and magy in y-direction
(iv) WOB (weight on bit) and TOB (torque on bit)
Number of samples corresponding to input time: tᵢ=sr*tᵢₙₚ where tᵢₙₚ is the measurement start time.
Number of samples corresponding to output time: tₒ=sr*tₒᵤₜ where tₒᵤₜ is the measurement stop time.
Number of samples of data points or measurements: nₛ=tₒ−tᵢ.

$$Total time = \frac{{n}_{s}}{sr} . \\ Time interval between consecutive data points = \frac{1}{sr}$$

Step 52 calls for computing instantaneous BHA rotational frequency (or BHA RPM (revolutions per minute)) using the magnetometer measurements as follows:

f=IFREQ(magx,magy,sr) where IFREQ is instantaneous frequency of rotation of the drill string

ω(t)=−2πf (Instantaneous frequency in rad/sec)

N(t)=−60ω(t) (Instantaneous RPM)

Note: Use negative sign for clockwise rotation
Take running average of RPM over 10 seconds in one embodiment to get Averaged Instantaneous RPM

Step 53 calls for processing bending data from strain gauges 23 and 24 as follows:

(i) Convert X & Y bending data (bₓ and b_{y}) to inch units
(ii) Compute instantaneous bending frequency f_{b} (Bending RPM)

f_{b}=IFREQ(bₓ,b_{y},sr)

ω_{b}=2πf_{b} (Instantaneous bending frequency in rad/sec)

N_{b}(t)=60ω_{b}(t) (Instantaneous bending RPM, running average over 10 seconds in one embodiment)

t=0, 1, 2, 3, . . . nₛ−1

(iii) Compute Whirl RPM (N_{w})

N_{W}(t)=N(t)−N_{b}(t): Whirl RPM

ω_{b}(t)=−2πN_{w}(t): Whirl RPM in radians/sec

t=0, 1, 2, . . . nₛ−1

Note: Use negative sign for clockwise rotation

(iv) Compute theoretical Whirl RPM

$${N}_{wt} ( t ) = \frac{- {d}_{o} N ( t )}{{d}_{h} - {d}_{o}} \text{:} Theoretical whirl RPM$$

t=0, 1, 2, . . . nₛ−1

(v) Calculate whirl radius using bending moment measurements

bₘ(t)=\sqrt{bₓ²(t)+b_{y}²(t)}

$${r}_{b} ( t ) = \frac{{b}_{m} ( t )}{con}$$

t=0, 1, 2, . . . nₛ−1

Step 54 calls for computing lateral displacement of the BHA in the borehole using lateral acceleration data and/or bending moment data as follows:

(i) Convert X,Y and Z acceleration data into inch units
(ii) Compute whirl radius using X & Y acceleration data

aₗ(t)=\sqrt{αₓ²(t)+α_{y}²(t)}

$${r}_{a} ( t ) = \frac{{a}_{l} ( t )}{2 {ω}_{b}^{2} ( t )}$$

t=0, 1, 2, . . . nₛ−1

(iii) Compute X and Y displacements of the sensor (point on drill collar) when whirling about borehole center with whirl rate ω_{b}:
(a) Using acceleration measurements

xₐ(t)=rₐ(t)cos(ω_{b}(t)*t)

yₐ(t)=rₐ(t)sin(ω_{b}(t)*t)

or
(b) Using bending moment measurements

x_{b}(t)=r_{b}(t)cos(ω_{b}(t)*t)

y_{b}(t)=r_{b}(t)sin(ω_{b}(t)*t)
t=0, 1, 2, . . . nₛ−1
Note: (a) Since the collar or BHA is restricted in its radial displacement by the borehole walls, therefore this restriction must be applied to these values too, i.e., if the radial displacement rₐ or r_{b} exceeds the borehole radius

$$\frac{{d}_{h}}{2} ,$$

then its maximum displacement is reached.
(b) If negative whirl speed exceeds the theoretical speed, the rotation is opposite to the RPM direction.

Step 55 calls for computing axial bit or BHA displacement using acceleration in the Z-direction as follows:

Compute axial displacement using double numerical integration of the acceleration data in the Z-direction.

Step 56 calls for drawing the borehole and the dynamic location of the collar or BHA inside of the borehole as follows:

(a) Draw borehole assuming round borehole having diameter of the drill bit or using borehole caliper data.
Determine location xₕ and yₕ of the borehole; Dividing the circumference into 1000 parts in one embodiment.

$${x}_{h} = \frac{{d}_{h}}{2} cos ( \frac{i * 2 * π}{{n}_{n}} )$$

$${y}_{h} = \frac{{d}_{h}}{2} sin ( \frac{i * 2 * π}{{n}_{n}} ) i = 0 , 1 , 2 , , … {n}_{n} - 1$$

where nₙ=1000

(b) Draw dynamic location of the BHA inside borehole
(i) Draw the BHA by dividing its circumference into, say 1000 parts. Thus each point on the circumference i.e. x_{cs} and y_{cs}, is given by

$${x}_{cs} = \frac{{d}_{c}}{2} cos ( \frac{i * 2 * π}{{n}_{n}} )$$

$${y}_{cs} = \frac{{d}_{c}}{2} sin ( \frac{i * 2 * π}{{n}_{n}} ) i = 0 , 1 , 2 , , … {n}_{n} - 1.$$

(ii) Determine dynamic location of the BHA inside borehole (using dynamic sensor locations given by xₐ & yₐ or x_{b} & y_{b}) (i.e., plot the BHA for each time location of BHA center)

x_{c}(t)=xₐ(t)+x_{cs}

y_{c}(t)=yₐ(t)+y_{cs}

(iii) Plot BHA axes for each time location of the BHA, taking into account the BHA rotation rate N or ω. Plot a line from:

x_{ab}(t)+0.5*d_{c}*cos [ω(t)*t]→x_{ab}(t)+0.5*d_{c}*cos [ω(t)*t+π]

and another line at 90 degrees to it

$${x}_{ab} ( t ) + 0.5 * {d}_{c} * cos ( ω ( t ) * t + \frac{π}{2} ) \to {x}_{ab} ( t ) + 0.5 * {d}_{c} * cos ( ω ( t ) * t + \frac{3 π}{2} ) .$$

Step 57 calls for determining and drawing bending moment vector and direction as follows:

$$Calculate θ ( t ) = - {tan}^{- 1} ( \frac{{b}_{x} ( t )}{{b}_{y} ( t )} )$$

Draw the bending moment vector on the BHA from point x_{bm0}(t), y_{bm0}(t) to point x_{bm1}(t), y_{bm1}(t), where

$${x}_{bm 0} ( t ) = {x}_{ab} ( t ) + \frac{{d}_{c}}{2} * sin [ θ ( t ) * t ]$$

$${y}_{bm 0} ( t ) = {y}_{ab} ( t ) + \frac{{d}_{c}}{2} cos [ θ ( t ) * t ]$$

$$and$$

$${x}_{bm 1} ( t ) = {x}_{ab} ( t ) + ( 1 - B {m}_{n} ) * \frac{{d}_{c}}{2} * sin [ θ ( t ) * t ]$$

$${y}_{bm 1} ( t ) = {y}_{ab} ( t ) + ( 1 - B {m}_{n} ) * \frac{{d}_{c}}{2} * sin [ θ ( t ) * t ]$$

where x_{ab} & y_{ab} are the time dependent sensor locations based on either BM or acceleration measurements i.e. xₐ & yₐ or x_{b} & y_{b}.
Note: Negative sign for clockwise rotation.
Note: Use similar procedure to draw normalized weight-on-bit (WOB) and torque-on-bit (TOB) on the BHA.

It can be appreciated that advantages of the visualization of a downhole portion of the drill string include the capability to visualize in real time: forward and backwards whirl, axial and lateral motion, chaotic motion; stick-slip bit bounce; axial, lateral and torsionally severe vibrations; axial, lateral and torsionally severe loads; and any combination of these. By visualizing these events or actions leading to these events in real time, a drilling operator can take actions to prevent damage to downhole components or increase the rate of penetration.

It can be appreciated that sampling downhole measurements with the electronic unit 11 at a high sampling rate such as greater than 100 Hz provides for a more detailed and accurate visualization of the dynamic motion of the BHA 10. Similarly, it can be appreciated that the high-speed telemetry system 12 can have the capability to transmit the data sampled at the high sampling rate in real time to the computer processing system 15.

In one or more embodiments where the bandwidth of the high-speed telemetry system 12 may be limited such as by a malfunction, the electronic unit 11 can down-sample the downhole measurements at a lower sampling rate than normal, but at a sample rate that still contains the signals representing the motions and loads of interest, such that the remaining bandwidth is used to transmit the measurements related to BHA motion and loads of interest. In this case, the original sample rate is recovered by up-sampling the received data in the surface computer processing system 15. Similarly, the electronic unit 11 can restore the downhole measurements to the normal or original sampling rate when the available bandwidth of the telemetry system 12 increases.

In one or more embodiments, the disclosed techniques for visualizing motion of the BHA 10 can be applied to previously recorded downhole sensor data in order to recreate the BHA motions that lead to the recorded accelerations and loads such as bending moments.

In one or more embodiments, the computer processing system 15 can be configured to play back BHA motions at a rate specified by the user, so that motions and loads can be examined with greater detail similar to playing back images recorded by a high-speed camera in slow motion. In this case, it is preferable that the sample rate be carefully adjusted using anti-aliasing filters when visually speeding up or slowing down the playback speed to avoid introducing visual aliasing (i.e., so that the represented motions are faithful to the measured motion.

In one or more embodiments, the computer processing system 15 can be configured to display conventional diagnostics or alarms and/or raw data traces alongside the display of motion visualization, so that the user gains an understanding of the motions and loads being experienced the BHA or drill string downhole.

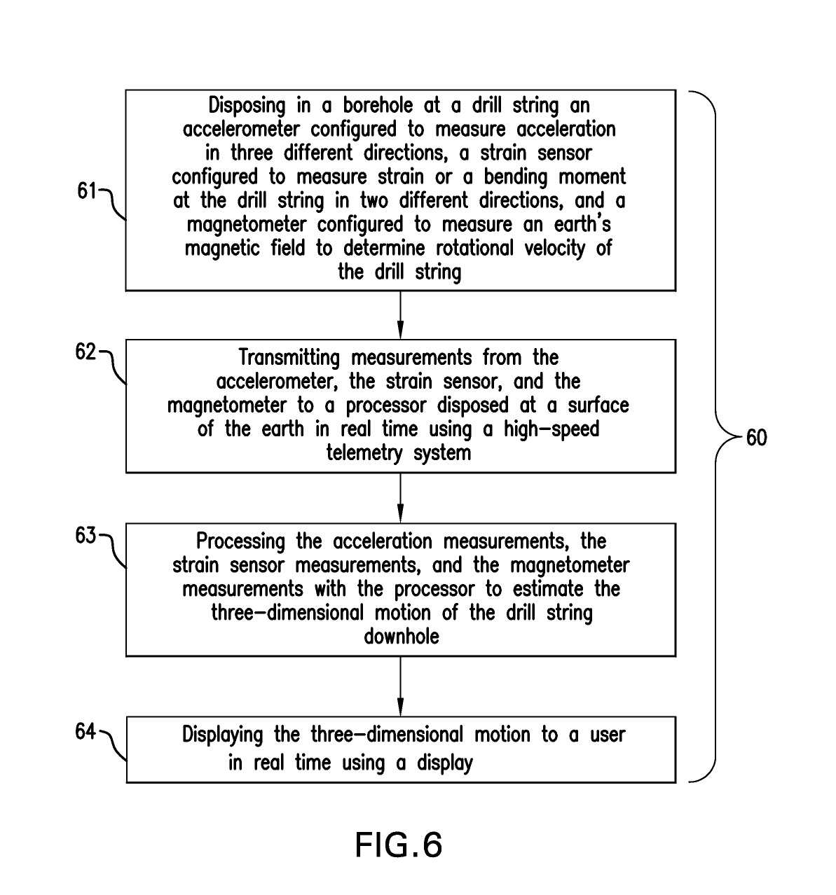

FIG. 6 presents one example of a method 60 displaying three-dimensional motion of a drill string in a borehole penetrating the earth to a user in real time. The method 60 calls for (step 61) disposing in the borehole at the drill string an accelerometer configured to measure acceleration in three different directions, a strain sensor configured to measure strain or a bending moment at the drill string in two different directions, and a magnetometer configured to measure an earth's magnetic field to determine rotational velocity of the drill string. Further, the method 60 calls for (step 62) transmitting measurements from the accelerometer, the strain sensor, and the magnetometer to a processor disposed at a surface of the earth in real time using a high-speed telemetry system. Further, the method 60 calls for (step 63) processing the acceleration measurements, the strain sensor measurements, and the magnetometer measurements with the processor to estimate the three-dimensional motion of the drill string downhole. Further, the method 60 calls for (step 64) displaying the three-dimensional motion to the user in real time using a display.

In support of the teachings herein, various analysis components may be used, including a digital and/or an analog system. For example, the downhole electronic device 11, the surface computer processing 15, or any of the downhole sensors may include the digital and/or analog system. The system may have components such as a processor, storage media, memory, input, output, communications link (wired, wireless, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a non-transitory computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, a power supply (e.g., at least one of a generator, a remote supply and a battery), cooling component, heating component, magnet, electromagnet, sensor, electrode, transmitter, receiver, transceiver, antenna, controller, optical unit, electrical unit or electromechanical unit may be included in support of the various aspects discussed herein or in support of other functions beyond this disclosure.

The term “drill string” as used herein relates to a string of jointed drill pipe and includes bottom-hole-assemblies, drill string inserts, modules, internal housings and substrate portions thereof. Hence, reference to motions and loads measured by sensors in these drill string components inherently refer to motions and loads experienced by the drill string. Similarly, the motions and loads can also refer to the drill bit when the sensors are in close proximity to the drill bit. In one or more embodiments, a bottom-hole-assembly can be a collar surrounding a portion of the drill string. Hence, reference to a bottom-hole-assembly inherently includes a collar.

Elements of the embodiments have been introduced with either the articles “a” or “an.” The articles are intended to mean that there are one or more of the elements. The terms “including” and “having” are intended to be inclusive such that there may be additional elements other than the elements listed. The conjunction “or” when used with a list of at least two terms is intended to mean any term or combination of terms. The terms “first,” “second” and the like are used to distinguish elements and are not used to denote a particular order. The term “couple” relates to coupling a first component to a second component either directly or indirectly through an intermediate component.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An apparatus for displaying three-dimensional motion of a drill string in a borehole penetrating the earth to a user in real time, the apparatus comprising:
an accelerometer disposed in the borehole at the drill string and configured to measure acceleration in at least three different directions;
a strain sensor disposed in the borehole at the drill string and configured to measure strain or a bending moment at the drill string in two different directions;
a magnetometer disposed in the borehole at the drill string and configured to measure an earth's magnetic field to determine rotational velocity of the drill string;
a processor disposed at a surface of the earth and configured to receive the measurements from the accelerometer, the strain sensor, and the magnetometer to process these measurements to estimate the three-dimensional motion of the drill string;
a display coupled to the processor and configured to display the three-dimensional motion of the drill string to the user; and
a high-speed telemetry system configured to transmit measurements from the accelerometer, the strain sensor, and the magnetometer to the processor in real time.

2. The apparatus according to claim 1, wherein the accelerometer comprises at least three accelerometers configured to measure acceleration in three orthogonal directions.

3. The apparatus according to claim 1, wherein the strain sensor comprises two strain sensors configured to measure the strain in two orthogonal directions or along two orthogonal axes in a plane intersecting the borehole.

4. The apparatus according to claim 3, wherein the strain sensor further comprises at least one additional strain sensor configured to measure weight on bit or torque on bit of a drill bit disposed at the drill string.

5. The apparatus according to claim 1, wherein the magnetometer comprises two magnetometers configured to measure magnetic fields in two orthogonal directions.

6. The apparatus according to claim 1, wherein the processor is further configured to display a reference point on an image of the drill string in order to depict rotation of the drill string.

7. The apparatus according to claim 1, wherein high-speed telemetry system is configured to transmit at least one of an electrical signal, an electromagnetic signal, an optical signal, and an acoustic signal.

8. The apparatus according to claim 1, wherein the processor is further configured to display a portion of the drill string and motion of the portion related to bit bounce, stick/slip, whirl, axial movement or lateral movement if any of these events occur.

9. The apparatus according to claim 1, wherein the processor is further configured to display a strain or bending moment experienced by the drill string.

10. The apparatus according to claim 9, wherein the strain or bending moment is displayed as shading on a displayed portion of the drill string.

11. The apparatus according to claim 10, wherein the shading comprises one or more colors to indicate a value of the strain or bending moment.

12. The apparatus according to claim 1, further comprising a pressure sensor configured to measure pressure internal to the drill string and external to the drill string and a temperature sensor disposed in the borehole at the drill string.

13. The apparatus according to claim 12, wherein the processor is further configured to display a raw data trace from any downhole sensor alongside the display of the three-dimensional motion of the drill string.

14. The apparatus according to claim 12, further comprising a downhole electronic device configured to sample downhole measurements at a selected first sampling rate for transmission by the high-speed telemetry system.

15. The apparatus according to claim 14, wherein the downhole electronic device is configured to sample select downhole measurements at a second sampling rate that is less than the first sampling rate after receipt of an indication of reduced bandwidth capacity from the high-speed telemetry system in order to use remaining bandwidth for transmission of accelerometer and strain sensor measurements.

16. The apparatus according to claim 15, wherein the downhole electronic device is further configured to sample the downhole measurements at the first sampling rate after receipt of an indication of normal bandwidth capacity.

17. The apparatus according to claim 1, wherein the processor is configured to display a diagnostic alert determined by the processor or by a downhole processor.

18. The apparatus according to claim 1, further comprising one or more sensor packages distributed along the drill string, each sensor package comprising:
an accelerometer disposed in the borehole at the drill string and configured to measure acceleration in at least three different directions;
a strain sensor disposed in the borehole at the drill string and configured to measure strain or a bending moment at the drill string in two different directions; and
a magnetometer disposed in the borehole at the drill string and configured to measure an earth's magnetic field to determine rotational velocity of the drill string;
wherein the accelerometer, the strain sensor, and the magnetometer in the sensor package are coupled to the high-speed telemetry system for transmission of measurements to the processor.

19. A method for displaying three-dimensional motion of a drill string in a borehole penetrating the earth to a user in real time, the method comprising:
disposing in the borehole at the drill string an accelerometer configured to measure acceleration in at least three different directions, a strain sensor configured to measure strain or a bending moment at the drill string in two different directions, and a magnetometer configured to measure an earth's magnetic field to determine rotational velocity of the drill string;
transmitting measurements from the accelerometer, the strain sensor, and the magnetometer to a processor disposed at a surface of the earth in real time using a high-speed telemetry system;
processing the acceleration measurements, the strain sensor measurements, and the magnetometer measurements with the processor to estimate the three-dimensional motion of the drill string downhole; and
displaying the three-dimensional motion to the user in real time using a display.

20. The method according to claim 19, further comprising displaying the measured strain or bending moment as shading on an image of a portion of the drill string at which the strain sensor is disposed.

21. The method according to claim 19, further comprising:
receiving measurements from a pressure sensor configured to measure pressure internal to the drill string and external to the drill string and measurements from a temperature sensor wherein the pressure sensor and the temperature sensor are disposed in the borehole at the drill string; and
displaying the pressure and temperature measurements on the display.

22. An apparatus for displaying three-dimensional motion of a drill string in a borehole penetrating the earth to a user in real time, the apparatus comprising:
an accelerometer disposed in the borehole at the drill string and configured to measure acceleration in at least three different directions;
a strain sensor disposed in the borehole at the drill string and configured to measure strain or a bending moment at the drill string in two different directions;
a magnetometer disposed in the borehole at the drill string and configured to measure an earth's magnetic field to determine rotational velocity of the drill string;
a processor disposed downhole at the drill string and configured to receive the measurements from the accelerometer, the strain sensor, and the magnetometer to process these measurements to estimate the three-dimensional motion of the drill string;
a display disposed at the surface of the earth and coupled to the processor and configured to display the three-dimensional motion of the drill string to the user; and
a high-speed telemetry system configured to transmit processed data related to the estimate of the three-dimensional motion from the processor to the display in real time.

23. A method for displaying three-dimensional motion of a drill string in a borehole penetrating the earth to a user in real time, the method comprising:
disposing in the borehole at the drill string an accelerometer configured to measure acceleration in at least three different directions, a strain sensor configured to measure strain or a bending moment at the drill string in two different directions, and a magnetometer configured to measure an earth's magnetic field to determine rotational velocity of the drill string;
receiving measurements from the accelerometer, the strain sensor, and the magnetometer with a processor disposed downhole at the drill string;
processing the acceleration measurements, the strain sensor measurements, and the magnetometer measurements with the processor to estimate the three-dimensional motion of the drill string downhole;
transmitting data related to the estimate of the three-dimensional motion from the processor to a display disposed at a surface of the earth in real time using a high-speed telemetry system; and
displaying the three-dimensional motion to the user in real time using the display.
